(19) United States
(12) Patent Application Publication
(10) Pub. No.: US 2008/0069265 A1
(43) Pub. Date: Mar. 20, 2008

(54) Transmitter

(75) Inventor: Jakob Ludvigsen, Copenhagen Osterbro (DK)

Correspondence Address: FOLEY & LARDNER LLP, P.O. BOX 80278, SAN DIEGO, CA, 92138-0278, US

(73) Assignee: Nokia Corporation

(21) Appl. No.: 11/522,020

(22) Filed: Sep. 15, 2006

(51) Int. Cl. H04L 27/00

(52) U.S. Cl. 375/295; 375/316

(57) ABSTRACT

A transmitter for transmitting signals over a communication channel, the signals comprising reference information known to a receiver arranged to receive the transmitted signals, the transmitter comprising: a modulator arranged to modulate a first data signal with a second data signal comprising reference information known to the receiver to generate a modulated data signal; and a transmitter arranged to transmit the modulated data signal.

### FIELD OF THE PRESENT INVENTION

The present invention relates to a transmitter and receiver for wireless communication. In particular, but not exclusively, the present invention relates to a method of transmitting and receiving a signal containing information in dependence on the communications environment.

### BACKGROUND TO THE INVENTION

Wireless communication systems are known. One known system is illustrated schematically in FIG. 1. The area covered by a wireless communication network 2 is divided into a number of cells 4. The cells may be side by side and/or overlapping. Each cell 4 is provided with a base station 6. Each base station 6 is arranged to communicate with mobile stations 8 or other user equipment located in the cells.

A number of different standards are known which regulate the communication between the base stations and the mobile stations. One commonly used standard is the GSM (Global System for Mobile Communications) standard. This is a digital communication system. In GSM, data is transferred between the mobile stations 8 and the base stations 6 as a radio signal over a physical channel which may use frequency and/or time division multiplexing to create a sequence of radio frequency channels and time slots. Each frequency band is divided into time division multiple access frames, with 8 users per frame. Each user is allocated time to send a single burst of information. Typically, the mobile station and base station which are in communication will use different frequency bands.

GSM can, in some implementations, use GMSK (Gaussian Minimum Shift Keying) modulation. GMSK modulation uses the phase of the radio signal in order to transmit the data. The phase of the signal is of course dependent on the frequency of the signal. In order to correctly identify the transmitted data, the frequency of the signal received at the receiving one of the base station and the mobile station should be within defined limits as compared to the intended frequency of transmission of that signal. If the frequency has shifted beyond these limits, then errors in the recovery of the data may occur.

Errors in the frequency at the receiving one of the mobile station and base station can occur for a number of reasons. For example, this can occur if one of the mobile station and the base station is moving. Usually, of course, the mobile station will move. Changes in the frequency can of course occur due to the Doppler shift. This effect is particularly marked when the mobile station is moving relatively fast. For example, high speed trains having a speed of around 330 km/hour are being proposed. At those speeds, the Doppler shift introduced by the movement of the mobile station would result in a relatively large frequency change. It should of course also be noted that movement at slower speeds will also result in Doppler shifts.

Movement of the mobile station relative the base station is not the only source of frequency changes. Other errors may be introduced. For example, multi-path propagation may change the frequency of the signal received. The oscillator of the transmitter may not be working correctly, for example due to changes in temperature, and accordingly the transmitted signal and hence the received signal is not at the correct frequency. Additionally, adverse weather conditions particularly very hot or very cold weather can change the condition of the radio channel which results again in a frequency shift of the received radio signals. In general, the changes in frequency are introduced either by radio frequency impairments or change in channel characteristics. The radio frequency impairments include multi-path propagation and variation in the crystal oscillator characteristics. These changes in channel characteristics include the effects due to movement and changes in weather conditions.

Generally, the GSM standard is reasonably robust. As such, it is able to cope with some variation in the frequency. However, errors from more than one source may be present which cumulatively provide a relatively large frequency error. Additionally, very fast moving mobile stations can introduce a relatively large frequency shift on their own.

During the evolution of the GSM standard several initiatives have been made to improve the quality and capacity of the system. For example, the introduction of adaptive multirate vocoders (AMR), downlink events radio performance (DARP) and receive diversity (RX diversity) have been used to improve the capacity of the GSM system.

One important way in which the GSM system maintains a level of quality in the communications links is the estimation of the channel characteristics. As has been described previously, the radio channels in mobile radio systems are multipath, where some of the pathways have different delay or phase change characteristics. These multiple paths can at the receiver produce inter-symbol interference (ISI). To remove the effect of the multiple pathways and the ISI from the signal an equalizer can be applied which effectively filters the received signal with a filter having the inverse characteristics of the multi-path environment.

However the equalizer variables are not the true channel characteristics but are obtained from a channel estimation process. The channel estimate is an estimate of the channel impulse response (CIR) which is provided by a channel estimator. The channel estimation is formed from receiving a known sequence of transmitted symbols over the multipath environment and estimating the effect of the channel on the known sequence. This known sequence is typically known as the training sequence (TS). Training sequences as used in the art are limited by the space available in each GSM burst allocated to the transmission of the training sequence. Although it is theoretically possible to increase the size of the training sequence portion of the burst, by increasing the size of the training sequence portion the amount of burst allocated to the GSM data is decreased therefore producing a trade-off between the amount of data that can be carried during a burst and the amount of training sequence data in the same burst. As the effectiveness of the channel estimation is dependent on the training sequence data the current fixed limit for the training sequence data significantly limits the quality of the GSM system.

### SUMMARY OF THE INVENTION

Embodiments of the present invention aim to at least partially address the above problem

There is provided according to the invention a transmitter for transmitting signals over a communication channel, the signals comprising reference information known to a receiver arranged to receive the transmitted signals, the transmitter comprising: a modulator arranged to modulate a first data signal with a second data signal comprising reference information known to the receiver to generate a modulated data signal; and a transmitter arranged to transmit the modulated data signal.

The modulator can be arranged to modulate the amplitude of the first data signal with the second data signal to generate the modulated data signal.

The modulator can be arranged to modulate the amplitude of the first data signal with the second data signal to generate the modulated data signal according to the equation: BNᵢ=SDᵢ+(C₁×TS₂ᵢ), wherein SDᵢ is the i'th bit of the first data signal, TS₂ᵢ the i'th bit of the second data signal, C₁ the modulation coefficient and BNᵢ the i'th bit of the modulated data signal.

The modulus of the modulation coefficient C₁ can be preferably greater than 0 and less than or equal to 0.25.

The transmitter may further comprise a source generator arranged to generate the first data signal.

The source generator may be a vocoder.

The transmitter may further comprise a second source generator arranged to generate the second data signal, the second data signal may comprise the reference information known to the receiver.

The second source generator may be a training sequence source generator.

The transmitter may further comprise a combiner arranged to append a third data signal to the modulated data signal, wherein the transmitter is further arranged to transmit the appended third data signal.

The second source generator may be further arranged to generate a third data signal.

The second and third data signals may be training sequence signals.

The second and third data signals may be the same training sequence signals.

The second and third data signals are preferably separate training sequence signals.

The separate training sequence signals are preferably complementary.

The combiner is preferably arranged to divide the first modulated data signal into a first part and a second part and may append the third data signal to the first part of the first modulated data signal and may append the second part of the first modulated data signal to the third data signal.

According to a second aspect of the present invention there is provided a transmitter for transmitting signals comprising reference information known to a receiver arranged to receive the transmitted signals, the transmitter comprising: means to modulate a first data signal with a second data signal comprising the reference information known to the receiver to generate a modulated data signal; and means arranged to transmit the appended third data signal and modulated data signal.

The transmitter may further comprise signal generating means arranged to generate a first data signal.

The transmitter may further comprise further signal generating means arranged to generate a second data signal.

The transmitter may further comprise means arranged to append a third data signal to the modulated data signal, wherein the third data signal may further comprise reference information known to the receiver.

The further signal generating means is preferably further arranged to generate the third data signal.

According to a third aspect of the present invention there is provided a receiver for receiving transmitted signals over a communication channel, the transmitted signals comprising at least a first part comprising reference information known to the receiver modulated with non-reference information, the receiver comprising:

an estimator circuit arranged to estimate the reference information to provide estimated information associated with the communication channel.

The receiver may further comprise a second estimator circuit arranged to determine an error between the received transmitted signals and the transmitted signals over the communication channel dependent on the estimated information.

The second estimator circuit may comprise an equalizer arranged to compensate the non-reference information for the error between the received transmitted signals and the transmitted signals.

The error preferably comprises a frequency error.

The second estimator circuit is preferably arranged to carry out one of a reduced state sequence estimation method and a decision feedback estimation method.

The receiver may further comprise a demodulator circuit arranged to separate the reference information and the non-reference information.

The transmitted signals may further comprise a second part comprising further reference information, the receiver may further comprise a third estimator circuit for estimating the further reference information to provide further estimated information associated with the communication channel.

The estimator circuit arranged to estimate the reference information to provide estimated information associated with the communication channel may be arranged to receive the further estimated reference information from the third estimator circuit.

The further reference information may comprise a training sequence.

The reference information may comprise a further training sequence.

The training sequence is preferably identical to the further training sequence.

According to a fourth aspect of the present invention there is provided a receiver for receiving transmitted signals over a communication channel, the transmitted signals comprising at least a first part comprising reference information known to the receiver modulated with non-reference information, said receiver comprising: means for estimating the reference information to provide estimated information associated with the communication channel.

The receiver may further comprise means for determining an error between the received transmitted signals and the transmitted signals over the communication channel dependent on the estimated information associated with the communication channel.

The receiver may further comprise means for compensating the received transmitted signals dependent on the determined error between the received transmitted signals and the transmitted signals.

The transmitted signals may further comprise a second part comprising further reference information, wherein the receiver may further comprise further means for estimating the further reference information to provide further estimated information associated with the communication channel.

The receiver may further comprise means for separating the reference information and the non-reference information in the first part of the received transmitted signal.

According to a fifth aspect of the present invention there is provided a method of transmitting signals over a communications channel comprising reference information known to a receiver arranged to receive the transmitted signals, comprising the steps of: modulating the first data signal with the second data signal comprising reference information known to the receiver to generate a modulated data signal; and transmitting the combined third data signal and modulated data signal.

The step of modulating may comprise the step of modulating the amplitude of the first data signal with the second data signal to generate the modulated data signal.

The step of modulating may comprise the step of modulating the amplitude of the first data signal with the second data signal to generate the modulated data signal according to the equation: BNᵢ=SDᵢ+(C₁×TS₂ᵢ), wherein SDᵢ is the i'th bit of the first data signal, TS₂ᵢ the i'th bit of the second data signal, C₁ the modulation coefficient and BNᵢ the i'th bit of the modulated data signal.

The modulus of the modulation coefficient C₁ is preferably greater than 0 and less than or equal to 0.25.

The method of transmitting signals may further comprise the step of generating the first data signal.

The step of generating the first data signal is preferably performed by a vocoder.

The method of transmitting signals may further comprise the step of generating the second data signal, the second data signal comprising the reference information known to the receiver.

The step of generating the second data signal preferably comprises generating a training sequence signal.

The method of transmitting signals may further comprise the step of appending a third data signal comprising further reference information known to the receiver to the modulated data signal.

The method of transmitting signals may further comprise the step of generating a third data signal.

The second and third data signals are preferably training sequence signals.

The second and third data signals are preferably the same training sequence signals.

The second and third data signals are preferably separate training sequence signals.

The separate training sequence signals are preferably complementary.

The step of appending may comprise the steps of dividing the first modulated data signal into a first part and a second part; appending the third data signal to the first part of the first modulated data signal; and appending the second part of the first modulated data signal to the third data signal.

According to a sixth aspect of the present invention there is provided a method of receiving transmitted signals over a communication channel, the transmitted signals comprising at least a first part comprising reference information known to the receiver modulated with non-reference information, said receiver comprising the steps of: estimating the reference information to provide estimated information associated with the communication channel.

The method of receiving may further comprise the step of determining an error between the received transmitted signals and the transmitted signals over the communication channel dependent on the estimated information.

The method of receiving may further comprise the step of compensating the non-reference information for the determined error between the received transmitted signals and the transmitted signals.

The error preferably comprises a frequency error.

The step of determining the error may comprise the step of performing one of a reduced state sequence estimation method and a decision feedback estimation method.

The method of receiving may further comprise the step of separating the reference information and the non-reference information.

The transmitted signals may further comprise a second part comprising further reference information, the method of receiving may further comprise the step of estimating the further reference information to provide further estimated information associated with the communication channel.

The step of estimating the reference information to provide estimated information associated with the communication channel is preferably arranged to receive the further estimated reference information from the step of estimating the further reference information to provide further estimated information associated with the communication channel.

The further reference information may comprise a training sequence.

The reference information may comprise a further training sequence.

The training sequence is preferably identical to the further training sequence.

According to a seventh aspect of the present invention there is provided a user equipment including the transmitter as described above.

According to a eighth aspect of the present invention there is provided a user equipment including the receiver as described.

According to a ninth aspect of the present invention there is provided a user equipment arranged to carry out a method of transmitting signals as described above over a communications channel comprising reference information known to a receiver arranged to receive the transmitted signals.

According to a tenth aspect of the present invention there is provided a user equipment arranged to carry out a method of receiving transmitted signals as described above over a communication channel, the transmitted signals comprising at least a first part comprising reference information known to the receiver modulated with non-reference information.

According to a eleventh aspect of the present invention there is provided a base station including a transmitter as described above.

According to a twelfth aspect of the present invention there is provided a base station including a receiver as described above.

According to a thirteenth aspect of the present invention there is provided a base station arranged to carry out a method of transmitting signals as described above over a communications channel comprising reference information known to a receiver arranged to receive the transmitted signals.

According to a fourteenth aspect of the present invention there is provided a base station arranged to carry out a method of receiving transmitted signals as described above over a communication channel, the transmitted signals comprising at least a first part comprising reference information known to the receiver modulated with non-reference information.

According to a fifteenth aspect of the present invention there is provided a computer program arranged to operate a computer to perform a method of transmitting signals as described above over a communications channel comprising reference information known to a receiver arranged to receive the transmitted signals.

According to a sixteenth aspect of the present invention there is provided a computer program arranged to operate a computer to perform a method of receiving transmitted signals as described above over a communication channel, the transmitted signals comprising at least a first part comprising reference information known to the receiver modulated with non-reference information.

According to a seventeenth aspect of the present invention there is provided a transmitter for transmitting signals over a communication channel, comprising reference information known to a receiver arranged to receive the transmitted signals, the transmitter comprising: a source generator arranged to generate a first data signal; a second source generator arranged to generate a second and a third data signal, the second and third data signal comprising the reference information known to the receiver; a modulator arranged to modulate the first data signal with the second data signal to generate a modulated data signal; a combiner arranged to append the third data signal to the modulated data signal; and a transmitter arranged to transmit the appended third data signal and modulated data signal.

According to a eighteenth aspect of the present invention there is provided a receiver for receiving transmitted signals over a communication channel, the transmitted signals comprising reference information known to the receiver, the receiver comprising: a first estimator circuit for estimating the first part of the reference information to provide estimated information associated with the communication channel; a demodulator circuit arranged to separate the further reference information and the non-reference information in the second part of the transmitted signal; a second estimator circuit arranged to estimate the further reference information to provide further estimated information associated with the communication channel; and a third estimator circuit arranged to determine an error between the received signal and the transmitted signal over the communication channel dependent on the estimated information and further estimated information and to compensate the non-reference information for the error between the received transmitted signals and the transmitted signals.

### BRIEF DESCRIPTION OF THE DRAWINGS

For a better understanding of the present invention and as to how the same may be carried into effect, reference will now be made by way of example to the accompanying drawings in which:

FIG. 1 shows a schematic view of a network;

FIG. 2 shows a diagrammatic representation of a burst in the GSM standard;

FIG. 3 shows a diagrammatic representation of a burst in a GSM network incorporating an embodiment of the invention;

FIG. 4 shows a schematic view of a transmitter and receiver arranged to process the burst of FIG. 2; and

FIG. 5 shows a schematic view of a transmitter and receiver arranged to produce and process the modified burst structure as shown in FIG. 3.

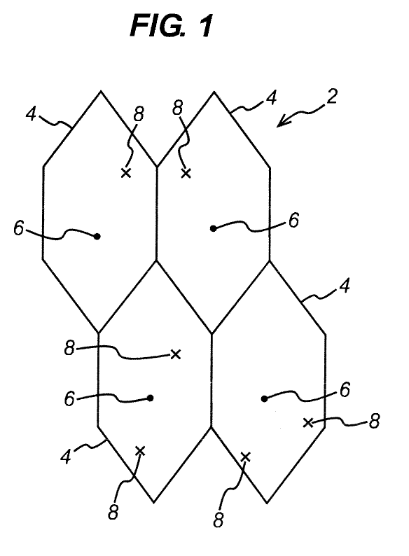

### DETAILED DESCRIPTION OF EMBODIMENTS OF THE PRESENT INVENTION

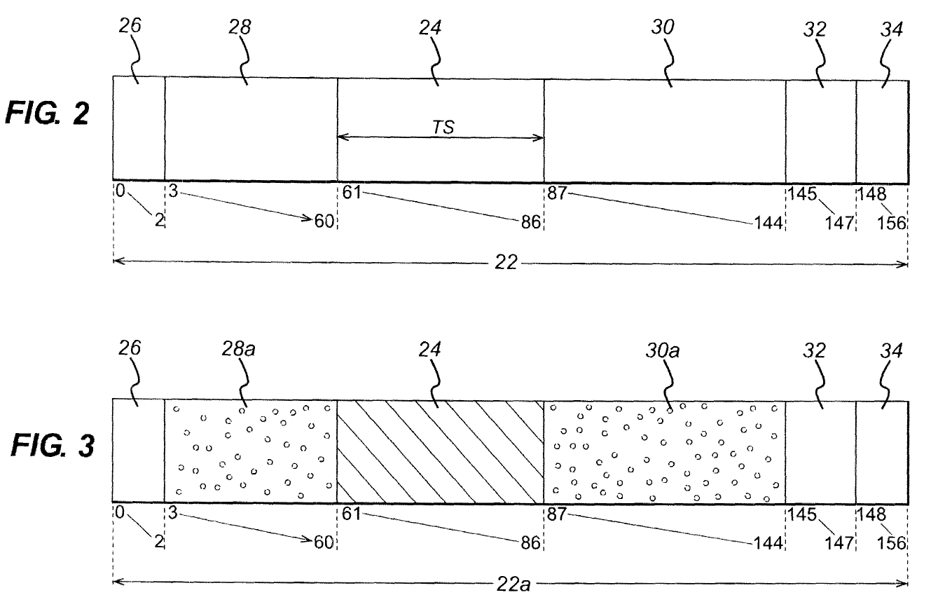

Reference will now be made to FIG. 2 which shows a diagrammatic representation of a GSM burst. In the GSM standard, the GMSK or 8PSK modulated data is formed into a burst created from 156.25 bits. The 156.25 bits are the number of bits which can fit into a time slot. The burst 22 has six components. A first “tailing bit” field 26 is provided. This first tailing bit field 26 comprises three symbols (0-2). Next is a first set of encrypted data 28. This consists of 58 bits (3-60). This is followed by a training sequence 24 which is 26 bits (61-86). The training sequence is known in advance by the receiver. This is known as a mid-amble as it comes between the two data fields. The training sequence comprises a 16 bit Viterbi channel equalizer training sequence surrounded on either side by 5 quasi-periodic repeated bits. The training sequence 24 is followed by a second data set 30 which again comprises 58 bits of encrypted data (87-144). Finally, this is followed by a second “tailing bit” field which comprises 3 bits (145-147). At the end of the burst is a guard period 34, which is empty and which extends for a period equivalent to 8.25 bits (148-156).

In the GMSK modulation scheme, a transmitted symbol is equivalent to a bit. Therefore there are 148 information bits in a burst. It should be appreciated that the training sequence symbols are known to the receiver in advance.

The frequency of the burst received by the receiving one of a mobile station and the base station frequently varies from the intended frequency of transmission of the burst by a certain amount of “frequency offset”. This frequency offset has the consequence of the phase of the signal change with time.

Embodiments of the present invention are arranged to compensate for any of the frequency offsets, regardless of the cause. For example, the frequency offset may be introduced by movement of the mobile station, changes in temperature, changes in component characteristics or the like.

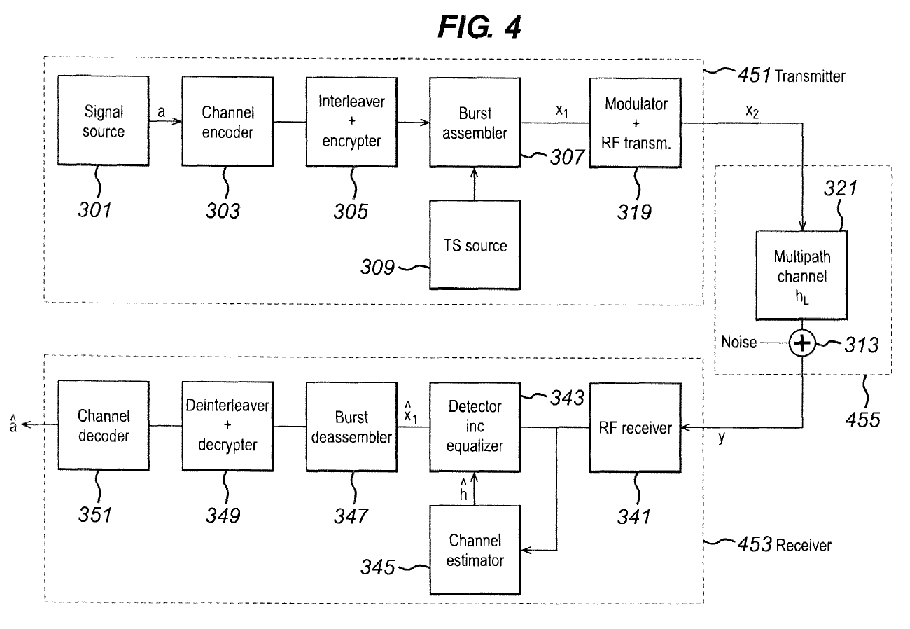

FIG. 4 shows in schematic form how the burst structure is created in the transmitter and decoded in the receiver to produce equalized estimated bits.

The transmitter 451 generates a bit signal source such in a signal source 301. For example the data bits can be generated from a GSM voice coder (vocoder) circuit (or from a separate digital source).

The data bits generated are then passed to the channel encoder 303. The channel encoder performs an encoding of the generated bits in an attempt to reduce the information rate through the channel and to increase the reliability of the channel. The channel encoder 303 outputs encoded bits to the next stage, the interleaver and encrypter 305.

The interleaver and encrypter 305 interleave the encoded bits and furthermore encrypt the data using a standard GSM bit encryption sequence. The output of the interleaver and encrypter is passed to the burst assembler 307.

The burst assembler 307 receives the interleaved and encrypted bits and also receives the training sequence source data TS from the training sequence source 309.

The burst assembler 307 produces the burst as shown in FIG. 2. This burst is output to the modulator and radio frequency transmitter element 319.

The modulator performs Gaussian minimum shift keying (GMSK) modulation converting the bits into symbols in line with the GSM transmission standard. This modulated radio frequency signal is then transmitted via an antenna or antennas (not shown) over the multipath environment.

The multipath environment is represented in FIG. 4 as block 455. The multipath environment can be considered to be modeled as a multipath channel filter (h_{L}) 321, which performs a finite impulse response (FIR) filtering of the transmitted radio frequency symbols. The delays and phase changes introduced by the filtering represent the various delay elements and phase changes generated by the environment such as reflections from urban environments. Furthermore the noise components such as the signals from other cells broadcasting on the same frequency are represented by an additive white Gaussian noise source 323 added to the output of the multipath channel filter.

The resultant effect of the multipath environment on the transmitted symbols is received at the input of the receiver via an antenna or antennas (not shown).

The receiver 453 receives the channel filtered radio frequency symbols at the radio frequency receiver element 341. The radio frequency receiver element demodulates the GMSK modulated signal and produces a base band frequency bits output. The base band bits output are passed to the detector 343 and also to the channel estimator 345.

The channel estimator 345 receives the demodulated base band bits signal and estimates the channel filter characteristics ĥ_{L} to determine the effect the channel has had on the known training sequence data. The estimated channel characteristics ĥ_{L} are passed to the detector 343. As the training sequence is 16 bits long the gain of the channel estimation is

G_{TN}=16²/(N₁)² (where N₁² is the power of the received noise for the period defined by the training sequence)

The detector 343, receives the base band signal from the RF receiver 341 and also the estimated channel characteristics ĥ_{L} from the channel estimator 345 is able to ‘equalize’ the received base band signal bits using the estimated channel characteristics by applying the inverse of the estimated channel characteristics to the base band bits.

Furthermore the detector estimates what each of the bit values represented in the received signal are. The equalized and estimated bits values are passed to the burst deassembler 347. The burst deassembler separates the training sequence and non data bits from the data bits of the equalized estimated base band bits and passes the estimated data bits to the deinterleaver and decrypter 349. This is effectively the reverse process of the burst assembler 307 where the training sequence and other data bits are combined with the data bits.

The deinterleaver and decrypter 349 receives the estimated data values and deinterleaves and decrypts these values (effectively the reverse process carried out in the transmitter in the interleaver and encrypter 305). The output of the deinterleaver and decrypter 349 is passed to the channel decoder 351.

The channel decoder 351 receives the deinterleaved and decrypted estimated data bits and performs a channel decoding on the bits. This process performs the inverse of the channel encoding process as carried out by the channel encoder 303 in the transmitter 451. The output of the channel decoder 351 is a facsimile of the bits generated by the signal source 301 in the transmitter 451. These bits can be inserted into a vocoder and passed to a speaker or to be used as received data bits.

FIG. 3 shows a schematic view of an improved GSM burst as used in embodiments of the present invention. The improved burst 22a is similar to the conventional GSM burst except for data parts 28a and 30a. Data parts 28a and 30a comprise in embodiments of the invention of a data part which is modulated with a training sequence TS₂. The training sequence modulates the amplitude of the source data as shown in the following equation.

BNᵢ=SDᵢ+(C₁×TS₂ᵢ),

where BN is the bit to be entered into the burst, SD an encoded source data bit, C₁ a modulation coefficient and TS₂ the training sequence value to modulate the encoded source data bit. The variable i is used to align the values and to indicate that although the values of BN, SD and TS can differ from bit to bit, the value of the modulation coefficient C₁ is constant during the modulation process.

In a preferred embodiment the modulus of the modulation coefficient |C₁|is 0.25. In other embodiments the modulus of the modulation coefficient is preferably greater than 0 and less than or equal to 0.25. In further embodiments the modulus of the modulation coefficient is any value greater than 0.

The gain from the channel estimation from the use of the training sequences is able to be determined in embodiments of the present invention as a combination of the previously described gain and the additional gain from the new training sequences used within the encoded source data parts of the burst. In mathematical terms the improved gain is represented by the equation:—

G_{improved}=G_{TN}+G_{TNC}

### Where G_{TNC} is defined by

G_{TNC}=(C₁×48×2)/(N₂²+M²) Equ 1

Where N₂² is the power of the received noise during the defined data period (in other words the period outside the training period) and M is the cancellation error of the modulation, in other words any residual source data not able to be removed when processing the training sequence values. The relationship between the received noise values N₁ and N₂ is:

6×(N₁)²=(N₂)²

This improvement can be seen in the table below which shows the theoretical maximum gain (G_{TN}+G_{TNC})/G_{TN} in the channel estimate that can be achieved from employing embodiments of the invention on the assumption that the cancellation of the source data is complete, i.e. M=0.

Noise Level

| | | 0.10 | 0.50 | 1.00 | 1.50 |
|---|---|---|---|---|---|
| C1 | 0.05 | 0.06 | 0.06 | 0.06 | 0.06 |
| | 0.10 | 0.25 | 0.25 | 0.25 | 0.25 |
| | 0.15 | 0.55 | 0.55 | 0.55 | 0.55 |
| | 0.20 | 0.93 | 0.93 | 0.93 | 0.93 |
| | 0.25 | 1.38 | 1.38 | 1.38 | 1.38 |
| | 0.30 | 1.88 | 1.88 | 1.88 | 1.88 |

Increasing the training sequence gain produces more accurate estimations of the multipath effects on the training sequence and therefore produces better multipath channel estimation and therefore more effective equalization of the communication channel than would be produced using only the single training sequence part.

Furthermore the use of the data parts, extending temporally beyond the normal range of bit positions in the burst allow a wider temporal estimation of the multipath environment and therefore further improve the estimate as it is less subject to transient errors.

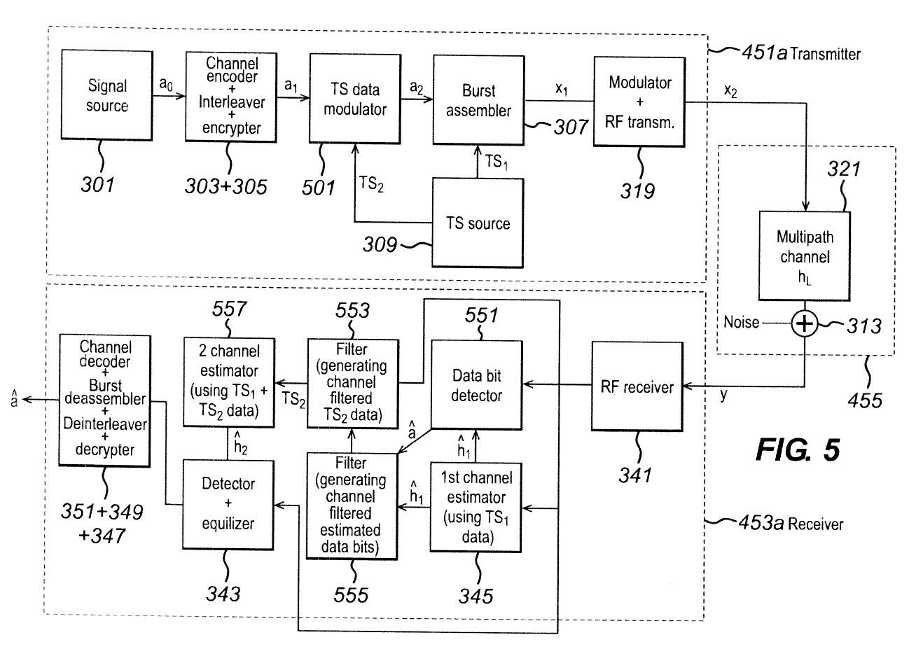

With regards to FIG. 5, an improved transmitter and receiver arrangement as used in embodiments of the invention which produces, decodes and uses the improved burst as shown in FIG. 4 to improve the performance for the GSM system.

Where components similar to the conventional GSM transmitter and receiver as shown in FIG. 4 are used, the same reference numerals have been used.

The signal source 301 is similar to the conventional signal source which generates digital bits to be transmitted by the transmitter 451a. The digital data is passed to the channel encoder 303 and interleaver and encrypter 305.

The channel encoder 303, interleaver and encrypter 305 blocks have been combined in FIG. 5, these blocks perform similar processes to those described with respect to the channel encoder, interleaver and encrypter as described above. The output from the encoder/interleaver/encrypter block is passed to a training sequence data modulator 501.

The training sequence data modulator 501 also receives a training sequence data source TS₂ from the TS data source unit 309. The TS data modulator 501 modulates the amplitude of the data received from the channel encoder and interleaver and encrypter 303 and 305 by adding the second training sequence data sequence TS₂, which is multiplied by a scaling or modulation factor C₁ in line with the description above to produce the modulated source data bits. The training sequence modulated source data bits are passed to the burst assembler 307.

The burst assembler also receives a training sequence from the training sequence source 309. This training sequence is similar to the conventional training sequence data bits which are inserted into the completed burst between the two data bit sequences. In the embodiment exemplifying the present invention the training sequence data bits are inserted into the completed burst between the two modulated data bit sequences. The output of the burst assembler is passed to the modulator and RF transmission unit 309 as previously disclosed above.

The modulator and RF transmission unit 319 transmits the GMSK signal via the multipath environment 455 in a manner similar to that as described above.

The improved receiver 453a receives the radio frequency modulated signal and inputs this to the RF receiver 341 in a manner as described above with regards to FIG. 4. The RF receiver then converts the received RF signal to a base band signal to be processed by the remainder of the receiver 453a.

The base band signal produced by the RF receiver 341 is output to the channel estimator 345, the data bit detector 551, the detector and equalizer 343 and the filter 553. The channel estimator 345 performs a task similar to that described above in that the channel estimator uses the training sequence segment of the baseband bits, in other words the channel modified training sequence data obtained from the middle part of the burst to produce a first channel estimation. This first channel estimation ĥ₁ is passed to the data bit detector 551 and to the filter 555.

The data bit detector/equalizer 551 on receiving the base band input signal from the RF receiver 341 and the channel estimator using the TS₁ training sequence bits, produces a first estimate for the source data bits. This process can be carried out by stripping the modulated training sequence data. In some embodiments the modulated training sequence bits are first filtered by the first channel estimation before being used to subtract the effect of the modulation training sequence from the source data bits. The remainder from the filter is then entered into a detector which selects the closest bit value as an estimate for each bit. The first estimated source data bits are passed to the filter 555.

The filter 555, on receiving the estimated first channel characteristics from the first channel estimator 345 and the estimated source data bits from the data bit detector 551, filters the estimated source data bits with the first channel estimated values to produce filtered estimated data bits. The channel filtered estimated data bits are then transmitted to the filter 553.

The filter 553, on receiving the base band input signal and the channel filtered estimated data bits, can produce estimated modulated training sequence bits TS₂ by filtering the base band input signal with the channel filtered estimated data bits. The received modulated training sequence bits TS₂ are then transmitted to the channel estimator 557.

The channel estimator 557, on receiving the received modulated training sequence bits TS₂, estimates the channel characteristics based on both the received modulated training sequence bits TS₂ and the received training sequence TS₁. The channel estimator 557 outputs a second channel estimation ĥ₂ to the detector and equalizer 343.

The detector and equalizer 343 receive the base band signal and the second channel estimation using both the TS₁ and TS₂ training sequences is able to produce an improved equalization and detection of the data sequences. The improved equalized and detected sequence is output to the channel decoder 351, deassembler 349, and deinterleaver and decrypter 347 which perform similar roles as discussed above. The output of the channel decoder 351, deassembler 349, and deinterleaver and decrypter 347 can as shown above generate a better estimated signal source because of the improved channel estimation.

The embodiments of the present invention introduce additional complexity to the improved receiver 453a as can be seen above in order to carry out the improved channel estimation and cancellation of the data signal, however the computing power required is less than the power required for downlink events radio performance (DARP) system and the memory requirements for the invention are less than the adaptive multirate vocoder (AMR) process.

In some embodiments of the present invention the TS₁ training sequence data is the same data sequence as the TS₂ training sequence. In some embodiments of the present invention the TS₁ and TS₂ training sequence are separate parts of a single training sequence and the channel estimator 557 receives both the TS₁ and TS₂ training sequence data before calculating the final channel estimation.

Embodiments of the present invention may be incorporated in a base station and/or a mobile station or other suitable user equipment. Such a base station/mobile station/user equipment may comprise one or both of the improved transmitter 451a and receiver 453a, or another implementation of a transmitter/receiver incorporating the modulated training sequence.

The preferred embodiment of the present invention has been described in the context of the GSM system using GMSK modulation. It should be appreciated that embodiments of the present invention can be used with different modulation methods which are reliant on frequency or a frequency depending characteristic. Embodiments of the present invention can of course be used with any other standard or communication method with the modulation used at least dependent on frequency. Embodiments of the present invention are just applicable to wireless cellular communication systems but can be used in any arrangement where signals are transferred using a modulated radio or the like signal.

The above described operations in the improved transmitter 451a and receiver 453a may require data processing in their implementation. The data processing may be provided by means of one or more data processors within the improved transmitter 451a and receiver 453a. Appropriately adapted computer program code product may be used for implementing the embodiments, when loaded to a computer or data processor. The program code product for providing the operation may be stored on and provided by means of a carrier medium such as a carrier disc, card, tape or memory integrated circuit. A possibility is to download the program code product via a data network. Implementation may be provided with appropriate software at a remote server.

1. A transmitter for transmitting signals over a communication channel, the signals comprising reference information known to a receiver arranged to receive the transmitted signals, the transmitter comprising:
a modulator arranged to modulate a first data signal with a second data signal comprising reference information known to the receiver to generate a modulated data signal; and
a transmitter arranged to transmit the modulated data signal.

2. A transmitter as claimed in claim 1, wherein the modulator is arranged to modulate the amplitude of the first data signal with the second data signal to generate the modulated data signal.

3. A transmitter as claimed in claim 2 wherein the modulator is arranged to modulate the amplitude of the first data signal with the second data signal to generate the modulated data signal according to the equation:
BNᵢ=SDᵢ+(C₁×TS₂ᵢ),
wherein SDᵢ is the i'th bit of the first data signal, TS₂ᵢ the i'th bit of the second data signal, C₁ the modulation coefficient and BNᵢ the i'th bit of the modulated data signal.

4. A transmitter as claimed in claim 3 wherein the modulus of the modulation coefficient |C₁| is preferably greater than 0 and less than or equal to 0.25.

5. A transmitter as claimed in claim 1, further comprising a source generator arranged to generate the first data signal.

6. A transmitter as claimed in claim 5, wherein the source generator is a vocoder.

7. A transmitter as claimed in claim 1, further comprising a second source generator arranged to generate the second data signal, the second data signal comprising the reference information known to the receiver.

8. A transmitter as claimed in claim 7, wherein the second source generator is a training sequence source generator.

9. A transmitter as claimed in claim 1, further comprising
a combiner arranged to append a third data signal to the modulated data signal, wherein the transmitter is further arranged to transmit the appended third data signal.

10. A transmitter as claimed in claim 9, wherein the second source generator is further arranged to generate a third data signal.

11. A transmitter as claimed in claim 9, wherein the second and third data signals are training sequence signals.

12. A transmitter as claimed in claim 9, wherein the second and third data signals are the same training sequence signals.

13. A transmitter as claimed in claim 9, wherein the second and third data signals are separate training sequence signals.

14. A transmitter as claimed in claim 13, wherein the separate training sequence signals are complementary.

15. A transmitter as claimed in claim 9, wherein the combiner is arranged to divide the first modulated data signal into a first part and a second part and append the third data signal to the first part of the first modulated data signal and append the second part of the first modulated data signal to the third data signal.

16. A transmitter for transmitting signals comprising reference information known to a receiver arranged to receive the transmitted signals, the transmitter comprising:
means to modulate a first data signal with a second data signal comprising the reference information known to the receiver to generate a modulated data signal; and
means arranged to transmit the appended third data signal and modulated data signal.

17. A transmitter as claimed in claim 16 further comprising signal generating means arranged to generate a first data signal.

18. A transmitter as claimed in claim 16 further comprising further signal generating means arranged to generate a second data signal.

19. A transmitter as claimed in claim 16 further comprising means arranged to append a third data signal to the modulated data signal, wherein the third data signal further comprises reference information known to the receiver.

20. A transmitter as claimed in claim 19, wherein the further signal generating means is further arranged to generate the third data signal.

21. A receiver for receiving transmitted signals over a communication channel, the transmitted signals comprising at least a first part comprising reference information known to the receiver modulated with non-reference information, the receiver comprising:
an estimator circuit arranged to estimate the reference information to provide estimated information associated with the communication channel.

22. A receiver as claimed in claim 21, further comprising a second estimator circuit arranged to determine an error between the received transmitted signals and the transmitted signals over the communication channel dependent on the estimated information.

23. A receiver as claimed in claim 22 wherein the second estimator circuit comprises an equalizer arranged to compensate the non-reference information for the error between the received transmitted signals and the transmitted signals.

24. A receiver as claimed in claim 22, wherein the error comprises a frequency error.

25. A receiver as claimed in claim 22, wherein the second estimator circuit is arranged to carry out one of a reduced state sequence estimation method and a decision feedback estimation method.

26. A receiver as claimed in claim 21, further comprising a demodulator circuit arranged to separate the reference information and the non-reference information.

27. A receiver as claimed in claim 22, wherein the transmitted signals further comprise a second part comprising further reference information, the receiver further comprising a third estimator circuit for estimating the further reference information to provide further estimated information associated with the communication channel.

28. A receiver as claimed in claim 27, wherein the estimator circuit arranged to estimate the reference information to provide estimated information associated with the communication channel, is arranged to receive the further estimated reference information from the third estimator circuit.

29. A receiver as claimed in claim 28, wherein the further reference information comprises a training sequence.

30. A receiver as claimed in claim 29, wherein the reference information comprises a further training sequence.

31. A receiver as claimed in claim 30, wherein the training sequence is identical to the further training sequence.

32. A receiver for receiving transmitted signals over a communication channel, the transmitted signals comprising at least a first part comprising reference information known to the receiver modulated with non-reference information, said receiver comprising:
means for estimating the reference information to provide estimated information associated with the communication channel.

33. A receiver as claimed in claim 32, further comprising means for determining an error between the received transmitted signals and the transmitted signals over the communication channel dependent on the estimated information associated with the communication channel.

34. A receiver as claimed in claim 33, further comprising means for compensating the received transmitted signals dependent on the determined error between the received transmitted signals and the transmitted signals.

35. A receiver as claimed in claim 32, wherein the transmitted signals further comprise a second part comprising further reference information, wherein the receiver further comprises further means for estimating the further reference information to provide further estimated information associated with the communication channel.

36. A receiver as claimed in claim 32 further comprising means for separating the reference information and the non-reference information in the first part of the received transmitted signal.

37. A method of transmitting signals over a communications channel comprising reference information known to a receiver arranged to receive the transmitted signals, comprising the steps of:
modulating the first data signal with the second data signal comprising reference information known to the receiver to generate a modulated data signal; and
transmitting the combined third data signal and modulated data signal.

38. A method of transmitting signals as claimed in claim 37, wherein the step of modulating comprises the step of modulating the amplitude of the first data signal with the second data signal to generate the modulated data signal.

39. A method of transmitting signals as claimed in claim 38, wherein the step of modulating comprises the step of modulating the amplitude of the first data signal with the second data signal to generate the modulated data signal according to the equation:
BNᵢ=SDᵢ+(C₁×TS₂ᵢ),
wherein SDᵢ is the i'th bit of the first data signal, TS₂ᵢ the i'th bit of the second data signal, C₁ the modulation coefficient and BNᵢ the i'th bit of the modulated data signal.

40. A method of transmitting signals as claimed in claim 39 wherein the modulus of the modulation coefficient |C₁| is preferably greater than 0 and less than or equal to 0.25.

41. A method of transmitting signals as claimed in claim 37, further comprising the step of generating the first data signal.

42. A method of transmitting signals as claimed in claim 41, wherein the step of generating the first data signal is performed by a vocoder.

43. A method of transmitting signals as claimed in claim 37, further comprising the step of generating the second data signal, the second data signal comprising the reference information known to the receiver.

44. A method of transmitting signals as claimed in claim 43, wherein the step of generating the second data signal comprises generating a training sequence signal.

45. A method of transmitting signals as claimed in claim 37, further comprising the step of appending a third data signal comprising further reference information known to the receiver to the modulated data signal.

46. A method of transmitting signals as claimed in claim 45, further comprising the step of generating a third data signal.

47. A method of transmitting signals as claimed in claim 46, wherein the second and third data signals are training sequence signals.

48. A method of transmitting signals as claimed in claim 46, wherein the second and third data signals are the same training sequence signals.

49. A method of transmitting signals as claimed in claim 46, wherein the second and third data signals are separate training sequence signals.

50. A method of transmitting signals as claimed in claim 49, wherein the separate training sequence signals are complementary.

51. A method of transmitting signals as claimed in claim 45, wherein the step of appending comprises the steps of
dividing the first modulated data signal into a first part and a second part;
appending the third data signal to the first part of the first modulated data signal; and
appending the second part of the first modulated data signal to the third data signal.

52. A method of receiving transmitted signals over a communication channel, the transmitted signals comprising at least a first part comprising reference information known to the receiver modulated with non-reference information, said receiver comprising the steps of:
estimating the reference information to provide estimated information associated with the communication channel.

53. A method of receiving as claimed in claim 52, further comprising the step of determining an error between the received transmitted signals and the transmitted signals over the communication channel dependent on the estimated information.

54. A method of receiving as claimed in claim 53 further comprising the step of compensating the non-reference information for the determined error between the received transmitted signals and the transmitted signals.

55. A method of receiving as claimed in claim 53, wherein the error comprises a frequency error.

56. A method of receiving as claimed in claim 53, wherein step of determining the error comprises the step of performing one of a reduced state sequence estimation method and a decision feedback estimation method.

57. A method of receiving as claimed in claim 53, further comprises the step of separating the reference information and the non-reference information.

58. A method of receiving as claimed in claim 53, wherein the transmitted signals further comprise a second part comprising further reference information, the method of receiving further comprising the step of estimating the further reference information to provide further estimated information associated with the communication channel.

59. A method of receiving as claimed in claim 58, wherein the step of estimating the reference information to provide estimated information associated with the communication channel, is arranged to receive the further estimated reference information from the step of estimating the further reference information to provide further estimated information associated with the communication channel.

60. A method of receiving as claimed in claim 58, wherein the further reference information comprises a training sequence.

61. A method of receiving as claimed in claim 60, wherein the reference information comprises a further training sequence.

62. A method of receiving as claimed in claim 60, wherein the training sequence is identical to the further training sequence.

63. A user equipment comprising a transmitter as claimed in claim 1.

64. A user equipment comprising a transmitter as claimed in claim 16.

65. A user equipment comprising a receiver as claimed in claim 32.

66. A user equipment comprising a receiver as claimed in claim 32.

67. A user equipment arranged to carry out a method of transmitting signals over a communications channel comprising reference information known to a receiver arranged to receive the transmitted signals as claimed in claim 3.

68. A user equipment arranged to carry out a method of receiving transmitted signals over a communication channel, the transmitted signals comprising at least a first part comprising reference information known to the receiver modulated with non-reference information, as claimed in claim 52.

69. A base station comprising a transmitter as claimed in claim 1.

70. A base station comprising a transmitter as claimed in claim 16.

71. A base station comprising a receiver as claimed in claim 21.

72. A base station comprising a receiver as claimed in claim 32.

73. A base station arranged to carry out a method of transmitting signals over a communications channel comprising reference information known to a receiver arranged to receive the transmitted signals as claimed in claim 37.

74. A base station arranged to carry out a method of receiving transmitted signals over a communication channel, the transmitted signals comprising at least a first part comprising reference information known to the receiver modulated with non-reference information, as claimed in claim 52.

75. A computer program arranged to operate a computer to perform a method of transmitting signals over a communications channel comprising reference information known to a receiver arranged to receive the transmitted signals, as claimed in claim 37.

76. A computer program arranged to operate a computer to perform a method of receiving transmitted signals over a communication channel, the transmitted signals comprising at least a first part comprising reference information known to the receiver modulated with non-reference information as claimed in claim 52.

77. A transmitter for transmitting signals over a communication channel, comprising reference information known to a receiver arranged to receive the transmitted signals, the transmitter comprising:
a source generator arranged to generate a first data signal;
a second source generator arranged to generate a second and a third data signal, the second and third data signal comprising the reference information known to the receiver;
a modulator arranged to modulate the first data signal with the second data signal to generate a modulated data signal;
a combiner arranged to append the third data signal to the modulated data signal; and
a transmitter arranged to transmit the appended third data signal and modulated data signal.

78. A receiver for receiving transmitted signals over a communication channel, the transmitted signals comprising reference information known to the receiver, the receiver comprising:
a first estimator circuit for estimating the first part of the reference information to provide estimated information associated with the communication channel;
a demodulator circuit arranged to separate the further reference information and the non-reference information in the second part of the transmitted signal;
a second estimator circuit arranged to estimate the further reference information to provide further estimated information associated with the communication channel; and
a third estimator circuit arranged to determine an error between the received signal and the transmitted signal over the communication channel dependent on the estimated information and further estimated information and to compensate the non-reference information for the error between the received transmitted signals and the transmitted signals.
